(19) United States
(12) Patent Application Publication
(10) Pub. No.: US 2020/0346930 A1
(43) Pub. Date: Nov. 5, 2020

(54) AGGLOMERATED SOLID MATERIAL MADE FROM LOOSE CARBON NANOTUBES

(71) Applicant: Arkema France, Colombes (FR)

(72) Inventors: Patrick Delprat, LACQ (FR); Alexander Korzhenko, LACQ (FR); Christophe Vincendeau, LACQ (FR); Daniel Cochard, LACQ (FR)

(73) Assignee: Arkema France, Colombes (FR)

(21) Appl. No.: 16/960,771

(22) PCT Filed: Jan. 10, 2019
(86) PCT No.: PCT/FR2019/050052

§ 371 Date: Jul. 8, 2020

(30) Foreign Application Priority Data
Jan. 12, 2018 (FR) 1850241

(51) Int. Cl. C01B 32/17; C01B 32/174

(52) U.S. Cl. CPC C01B 32/17; C01B 32/174; C01P 2006/10; C01P 2006/11; C01P 2004/64; C01P 2004/03

(57) ABSTRACT

An agglomerated solid material comprising loose carbon nanotubes and that is free from organic compounds is described, as well as the method of preparation thereof, and uses thereof, where the agglomerated solid material consists of a continuous network of carbon nanotubes comprising aggregates of carbon nanotubes with an average size d50 under 5 μm, in a proportion below 60% by area, determined by image analysis by electron microscopy and has an apparent density between 0.01 g/cm³ and 2 g/cm³.

### FIELD OF THE INVENTION

The invention relates to an agglomerated solid material comprising loose carbon nanotubes that is free from organic compounds, as well as to the method of preparation thereof, and the uses thereof.

### TECHNICAL BACKGROUND

Carbon nanotubes are now recognized to be materials offering great advantages, owing to their mechanical properties, their very high aspect ratios (length/diameter) as well as their electrical properties.

In fact it will be recalled that carbon nanotubes (hereinafter: CNTs) possess particular crystalline structures, of tubular shape, hollow, and closed but may, however, have open ends, made up of atoms arranged regularly in pentagons, hexagons and/or heptagons, obtained from carbon. CNTs generally consist of one or more rolled-up sheets of graphite. Thus, a distinction is made between single-walled nanotubes (SWNTs) and multiwalled nanotubes (MWNTs).

Note, furthermore, that carbon nanotubes usually have an average diameter from 0.1 to 200 nm, preferably from 0.1 to 100 nm, and advantageously a length of more than 0.1 μm and advantageously from 0.1 to 20 μm. Thus, their length/diameter ratio is advantageously greater than 10 and most often greater than 100.

CNTs may be produced by various methods; however, synthesis by chemical vapour deposition (CVD) provides manufacture of CNTs in large quantities.

Generally, the methods of synthesis of CNTs by the CVD technique consist of bringing a carbon source into contact, at a temperature between 500 and 1500° C., with a catalyst, generally in the form of a fluidized bed of metal-coated substrate grains.

The synthesized CNTs adhere to the catalytic substrate grains in the form of an entangled three-dimensional network, forming powder comprising agglomerates of CNTs with an average size of the order of some hundreds of microns. Typically, the agglomerates, which are also called primary aggregates, have an average size d50 of the order of 300 to 600 microns, d50 representing the apparent diameter of 50% of the population of agglomerates. The CNTs thus obtained may be used as they are, but it is also possible to have them undergo an additional further step of purification, intended to remove the grains of the catalytic substrate.

From observation by electron microscopy, at the micron scale, the surface of the CNTs in a primary aggregate has a granular structure, characterizing a disordered entanglement of CNTs.

The naturally entangled structure of the CNTs limits their use in certain applications, because of the difficulty of integrating aggregates larger than a few hundreds of microns homogeneously in certain matrices.

It has thus been proposed to reduce the size of the CNT agglomerates during their production, for example by the method described in document WO 2007/074312. This method includes a grinding step, inside or outside of the synthesis reactor, making it possible to limit the size of the entangled three-dimensional network of CNTs on the catalyst, and make active catalytic sites of said catalyst accessible.

This method makes it possible to limit the formation of CNT agglomerates larger than 200 μm and/or reduce their number, and produces CNTs of higher purity while significantly improving the productivity of the catalyst employed.

However, grinding, carried out by the known techniques in equipment such as ball mills, hammer mills, edge runner mills, cutting mills or gas jet mills, makes it possible to divide the primary aggregates into smaller aggregates, notably having an average size d50 between 10 and 200 μm, but does not alter the entanglement of the CNTs. As a result, the nature of the aggregates is unchanged and the processability of the CNTs thus obtained is not improved.

Furthermore, this method does not make it possible to overcome the problems of handling of the CNTs, owing to their pulverulent character.

In order to solve these problems, it is proposed in document WO 17/126775 to prepare CNT granules starting from a mixture of CNTs in the form of powder with a dispersing solvent, in a weight ratio from 5:1 to 1:2, and extrude the paste obtained in the form of granules, which are then dried. A feature of this method is that it only uses a small amount of solvent. The granules thus obtained have a higher apparent density than the density of the CNT powder, in particular a density above 90 kg/m³ and generally below 250 kg/m³. The solvent employed may be selected from a long list of compounds, such as water, alcohols (methanol, ethanol, propanol), ketones (acetone), amides (dimethylformamide, dimethylacetamide), esters or ethers, aromatic hydrocarbons (benzene, toluene) or aliphatic hydrocarbons. This method makes it possible to compact the CNT powder and reduce the average size d50 of the agglomerates making up the CNT granules by more than 60% relative to the size of the agglomerates making up the CNT powder. The granules thus obtained generally have a particle size d50 below 200 μm, preferably below 150 μm, and even below 20 μm, or even below 15 μm. However, the morphology of the aggregates, i.e. the entanglement of the CNTs, does not appear to be altered by this method.

WO 2008/000163 describes a method for preparing aerogels of carbon nanotubes comprising aggregates of well dispersed carbon nanotubes having a diameter of about 1 nm to about 100 microns and a density ranging from 0.1 to about 100 g/l. These aerogels are solvent-free and are used to prepare membranes for carbon nanotubes and nanocomposite materials.
Document WO 2012/080626 describes a process for the introduction of nanofillers of carbonic origin into a metal or a metal alloy. The result is a metallic composite comprising well dispersed nanofillers, of density close to that of metal, usable for the production of metallic structures,

Other approaches have been proposed for solving the problems of handling CNTs in the powdered state. It has notably been proposed to disperse the CNTs in various receiving matrices in order to form masterbatches of CNTs and thus use CNTs in agglomerated solid form of macroscopic size. These masterbatches are ready to use and may be introduced in total safety into a matrix to form composites with improved properties. Preferably, the receiving matrix of the masterbatch of CNTs is selected so as to correspond to, or be compatible with, the matrix of the composite material.

Generally, according to these methods, the primary aggregates are broken up by the mechanical shearing employed for dispersing the CNTs uniformly in a liquid or viscoelastic receiving matrix.

Various preparations of such masterbatches are described in the prior art, for example in documents WO 09/047466; WO 10/109118; WO 10/109119; WO 2011/031411; WO 2011/117530; WO 2014/080144; WO 2016/066944; WO 2016/139434 in the applicant's name.

These methods are mostly based on the principle of compatibility between the CNTs and the receiving matrix leading to uniform dispersion of the CNTs, and consequently are aimed at modifying the CNT-receiving matrix interfaces.

For this purpose, organic compounds may be introduced for modifying the CNT-receiving matrix interfaces, generally surfactants, dispersants, plasticizers, or other compounds of an essentially organic nature.

The presence of an organic compound on the surface of CNTs is acceptable for many fields of application. However, certain fields of application require the use of pure CNTs, especially CNTs free from organic compounds that could contaminate the matrix into which they are introduced to form a composite material with improved properties.

Therefore there is still a need for carbon nanotubes that are free from any trace of organic contaminant on their surface and are in an agglomerated solid form suitable for preparing homogeneous dispersions.

Thus, the present invention meets this need by supplying an agglomerated solid material comprising carbon nanotubes free from organic compounds that are no longer in the form of primary aggregates as obtained in the synthesis of these carbon nanotubes.

### SUMMARY OF THE INVENTION

The invention relates firstly to an agglomerated solid material comprising loose carbon nanotubes (CNTs) that are free from organic compounds, consisting of a continuous network of carbon nanotubes comprising aggregates of carbon nanotubes with an average size d50 under 5 μm, in a proportion under 60% by area determined by image analysis by electron microscopy.

The agglomerated solid material according to the invention has an apparent density of between 0.01 g/cm3 and 2 g/cm3.

The agglomerated solid material may be in any rough shape, or for example of spherical or cylindrical shape, in the form of flakes, granules, bricks or other massive bodies etc., with smallest dimension larger than one millimetre, preferably greater than 3 mm, without any limitation on size.

According to a preferred embodiment, the agglomerated solid material is in the form of granules.

“Free from organic compounds” means that the weight loss between 150° C. and 350° C. is less than 1% by the TGA method in air carried out with a temperature rise of 5° C./min.

“Loose” means that in the bulk, the CNTs no longer have the primary aggregates obtained during synthesis. The morphology of the agglomerated solid material according to the invention does not correspond to a material maintaining the shape memory of the primary aggregates resulting from the synthesis of the CNTs, but the size (diameter, number of walls) of the CNTs making up this agglomerated solid material is not altered. The present invention therefore excludes the agglomerated solid material consisting of carbon nanotubes in the form of compressed primary aggregates. The morphology of the agglomerated solid material of the invention is characterized by image analysis by electron microscopy, leading to determination of the mean proportion of aggregates with size d50 under 5 μm present on a sample area of 20×20 μm² according to the following method:

Ten electron microscopy images are obtained on an area of 20 μm×20 μm, 5 in the zones rich in aggregates and 5 in the zones where the aggregates are less visible. All the images are obtained on a fresh fracture of the solid material.
The images are analysed in order to select the identifiable shapes with size between 0.5 and 5 μm. The identifiable shapes are either the aggregates (light zones) or the voids (dark zones).
The grey zones attributed to the continuous network of CNTs are regarded as the area of the image background that is not covered by the identifiable shapes.
The percentage of the area of the image filled by identifiable shapes is calculated as follows: S (identifiable shapes, in μm²)*100/400 μm².
“Continuous network” means the image background in electron microscopy of the agglomerated solid material, which is not covered by aggregates with size d50 under 5 μm. According to the invention, the continuous network of CNTs does not comprise a shape or a clearly defined shape and is unclassifiable at the scale of 0.5-5 microns.
According to the invention the continuous network represents more than 40% by area according to image analysis.

According to one embodiment of the invention, the surface of the carbon nanotubes making up the agglomerated solid material may have a certain level of oxidation.

According to one embodiment of the invention, the agglomerated solid material may contain at least one chemical compound of an inorganic nature intimately incorporated in the continuous network of carbon nanotubes. The inorganic materials comprise entities of a metallic nature, carbon, silicon, sulphur, phosphorus, boron, and other solid elements; metal oxides, sulphides, and nitrides; hydroxides and salts; ceramics of complex structure or mixtures of all these inorganic materials.

According to one embodiment, the agglomerated solid material contains carbon in the form of other carbon-based nanofillers such as graphene, graphite, or carbon black at a content suitable for the intended application.

These chemical compounds of an inorganic nature may have a different form factor, isotropic or anisotropic, and a maximum dimension of 1 mm.

According to one embodiment, the apparent density of the agglomerated solid material is between 0.1 and 1.0 g/cm³.

The invention also relates to a method for preparing said agglomerated solid material.

The method of preparation according to the invention is characterized in that it comprises at least one step of compression of a CNT powder in the presence of at least one sacrificial substance, and optionally of at least one inorganic compound, followed by high-shear mixing of the powder in the compressed state, then forming to obtain an agglomerated solid material and final removal of the sacrificial substance.

The CNT powder may be a CNT powder obtained directly from the synthesis reactor, or a CNT powder that has undergone preliminary grinding and/or a purification treatment or any chemical treatment, or mixing with a compound of an inorganic nature.

The step of compressing the CNT powder leads to denser compacted CNTs, with an apparent density far higher than the apparent density of the CNTs in the powdered state.

High-shear mixing of the powder in the compressed state makes it possible to ensure shearing of the CNT aggregates present in the powder, in order to reduce their size, and simultaneously change the nature of entanglement of the CNTs in the aggregates, or make the aggregates disappear completely, so as to obtain a continuous network of CNTs.

The compression step and the high-shear mixing step are advantageously carried out in a compounding device.

“Sacrificial substance” means a substance that does not alter the surface of the CNTs after its final removal. It may be a liquid, solid or supercritical compound. The sacrificial substance may be water, a solvent, an organic molecule or a polymer, or mixtures thereof in all proportions. The sacrificial substance may be of a hydrophilic or hydrophobic nature.

The sacrificial substance may be removed by any means appropriate to its nature, for example by drying, calcination, thermal cracking, pyrolysis, degassing, etc. The sacrificial substance is selected in such a way that it can be removed completely without leaving any trace or residue in the end product.

The weight ratio of the CNTs to the sacrificial matrix is selected as a function of the density of the desired agglomerated solid material.

Advantageously, the percentage porosity of the agglomerated solid material corresponds to the volume fraction of the sacrificial substance.

According to one embodiment, the method of preparing the agglomerated solid material according to the invention is characterized in that it comprises at least the following steps implemented in the process:
a) charging a compounding device with CNTs in the powdered state and at least one sacrificial substance in a weight ratio from 10/90 to 40/60, preferably from 10/90 to 32/68, and optionally at least one inorganic compound;
b) mixing the CNTs and the sacrificial substance in said device to form a mixture in an agglomerated physical form;
c) recovering the mixture in the form of agglomerated solid material;
d) removing the sacrificial matrix.
Steps b) and c) may be repeated in order to achieve a higher level of disintegration.

“Compounding device” means, according to the invention, equipment used conventionally in the plastics industry for mixing thermoplastic polymers and additives in the molten state in order to produce composites.

Compounding devices are familiar to a person skilled in the art and generally comprise feeding means, notably at least one hopper for pulverulent materials and/or at least one injection pump for liquid materials; means for high-shear mixing, for example a co-rotating or counter-rotating double-screw extruder or a co-kneader, a conical mixer, or any type of screw mixer, usually comprising an endless screw arranged in a heated barrel (tube); a discharge head, which gives the outgoing material its form; and means for cooling the material, in air or using a water circuit. The material is generally in the form of rod leaving the device continuously and which may be chopped or made into the form of granules. However, other shapes may be obtained by fitting a die of the desired shape on the discharge die.

The invention further relates to the agglomerated solid material that is obtainable according to the method of the invention.

Employing a certain proportion of a sacrificial substance in the method according to the invention makes it possible to adapt the density and/or porosity desired for the agglomerated solid material.

The loose CNTs making up the agglomerated solid material obtained according to the method of the invention are more readily dispersible in a large variety of media, liquid, solid, or in the molten state, relative to CNTs in the powdered state. They are therefore used advantageously for conferring improved properties notably of conductivity or of mechanical strength in many fields of application.

The invention also relates to the use of the agglomerated solid material according to the invention or obtained according to the method of the invention for incorporating carbon nanotubes in water-based or organic liquid formulations.

The invention also relates to the use of the agglomerated solid material according to the invention or obtained according to the method of the invention for manufacturing composite materials, of the thermoplastic or thermosetting type.

The invention also relates to the use of the agglomerated solid material according to the invention or obtained according to the method of the invention for preparing elastomer compositions.

The invention also relates to the use of the agglomerated solid material according to the invention or obtained according to the method of the invention for making components of batteries and supercapacitors.

The invention also relates to the use of the agglomerated solid material according to the invention or obtained according to the method of the invention for preparing electrode formulations for lithium-ion batteries, lithium-sulphur batteries, sodium-sulphur batteries, or lead-acid batteries or other types of energy storage systems.

The invention also relates to the use of the agglomerated solid material according to the invention or obtained according to the method of the invention for preparing catalyst supports constituting electrodes.

The present invention makes it possible to overcome the drawbacks of the prior art while respecting the constraints connected with occupational health and hygiene.

### BRIEF DESCRIPTION OF THE FIGURES

FIG. 1 is an SEM image of the morphology of the agglomerated solid material according to the invention.

FIG. 2 is an SEM image of the morphology of a CNT powder (comparative).

### DETAILED DESCRIPTION OF THE INVENTION

The invention is now described in more detail, and non-limiting, in the description given hereunder.

The loose carbon nanotubes making up the agglomerated solid material according to the invention may be of the single-walled (SWNT), double-walled (DWNT) or multiwalled (MWNT) type.

Carbon nanotubes usually have an average diameter from 0.1 to 200 nm, preferably from 0.1 to 100 nm, more preferably from 0.4 to 50 nm, and better still from 1 to 30 nm, or even from 10 to 15 nm, and advantageously a length of more than 0.1 μm and advantageously from 0.1 to 20 μm, preferably from 0.1 to 10 μm, for example of about 6 μm. Their length/diameter ratio is advantageously greater than 10 and most often greater than 100.

They may have closed and/or open ends. These nanotubes are generally obtained by chemical vapour deposition. Their specific surface area is for example between 100 and 300 m²/g, advantageously between 200 and 300 m²/g, and their apparent density may notably be between 0.01 and 0.5 g/cm³ and more preferably between 0.07 and 0.2 g/cm³. Multiwalled carbon nanotubes may for example comprise from 5 to 15 sheets and more preferably from 7 to 10 sheets.

An example of crude CNTs in the powdered state usable for preparing the loose CNTs according to the invention is notably the trade name Graphistrength® C100 from the Arkema company.

According to one embodiment of the invention, the loose CNTs comprise metallic or mineral impurities, in particular the metallic and mineral impurities derived from the synthesis of crude CNTs in the powdered state. The amount of non-carbon impurities may be between 2 and 20 wt %.

According to one embodiment of the invention, the loose CNTs are free from metallic impurities, and result from crude CNTs in the powdered state that have been purified in order to remove the impurities inherent in their synthesis.

The crude or ground nanotubes may be purified by washing with a solution of sulphuric acid, so as to remove any residual mineral and metallic impurities from them, for example such as iron derived from the method of preparation. The weight ratio of nanotubes to sulphuric acid may notably be between 1:2 and 1:3. The purification operation may, moreover, be carried out at a temperature from 90 to 120° C., for example for a time from 5 to 10 hours. This operation may advantageously be followed by steps of rinsing with water and drying the purified nanotubes. The nanotubes may as a variant be purified by thermal treatment at high temperature, typically above 1000° C.

According to one embodiment of the invention, the loose CNTs are oxidized CNTs.

Oxidation of the nanotubes is advantageously carried out by bringing them into contact with a solution of sodium hypochlorite containing from 0.5 to 15 wt % of NaOCl and preferably from 1 to 10 wt % of NaOCl, for example in a weight ratio of nanotubes to sodium hypochlorite from 1:0.1 to 1:1. Oxidation is advantageously carried out at a temperature below 60° C. and preferably at room temperature, for a time from a few minutes to 24 hours. This operation of oxidation may advantageously be followed by steps of filtration and/or centrifugation, washing and drying of the oxidized nanotubes.

The loose CNTs form a continuous network comprising CNT aggregates with an average size d50 under 5 μm, in a proportion below 60% by area determined by image analysis by electron microscopy.

The proportion of aggregates with an average size d50 under 5 μm is preferably below 40% by area, more preferably below 20% by area, or even below 10% by area.

The continuous network of CNTs preferably represents more than 60% by area, more preferably more than 80% by area, or even more than 90% by area, according to image analysis by electron microscopy.

The loose CNTs are free from organic compounds on their surface.

A method for preparing the loose CNTs making up the agglomerated solid material of the invention uses a compounding device to compress a CNT powder and shear the CNT aggregates so as to reduce their size and the entanglement of the CNTs.

Examples of co-kneaders usable according to the invention are the BUSS® MDK 46 co-kneaders and those of the series BUSS® MKS or MX, marketed by the company BUSS AG, which all consist of a screw shaft provided with flights, arranged in a heating barrel optionally consisting of several parts and whose inside wall is provided with kneading teeth suitable for interacting with the flights to produce shearing of the material being kneaded. The shaft is rotated, and is provided with oscillating motion in the axial direction, by a motor. These co-kneaders may be equipped with a granule-producing system, fitted for example at their discharge orifice, and which may consist of an extrusion screw or a pump.

The co-kneaders usable according to the invention preferably have a screw ratio L/D in the range from 7 to 22, for example from 10 to 20, whereas the co-rotating extruders advantageously have a ratio L/D from 15 to 56, for example from 20 to 50.

To achieve optimum shearing of the CNT aggregates as well as minimum entanglement of the CNTs in the aggregates, it is generally necessary to apply considerable mechanical energy, which is preferably above 0.05 kWh/kg of material, in the compounding device.

According to the method of the invention, compounding of the powder is carried out in the presence of a sacrificial substance in a weight ratio from 10:90 to 40:60, preferably from 10:90 to 32:68, or even from 20:80 to 30:70, so as to obtain agglomerated particles comprising loose CNTs and the sacrificial substance, the sacrificial substance then being removed to form the loose CNTs free from organic compounds. It has in fact been shown that in this ratio, optimum compounding is possible for a wide range of sacrificial substances.

The following may be used as sacrificial substances, although this is not an exhaustive list: a solvent that does not leave any residue after it is removed by drying the agglomerated solid material, or an organic substance that does not leave any residues after pyrolysis of the agglomerated solid material, or a substance in the supercritical state that does not leave any residue after degassing, for example supercritical CO₂.

Preferably water, an alcohol, or other hydrophilic solvents, as well as mixtures thereof, preferably water, are used as the solvent.

Preferably, a polymer such as a polypropylene PP, a polyethylene terephthalate PET, a polycarbonate PC, a polyamide PA, preferably a polypropylene PP, is used as the organic substance.

According to one embodiment, it is possible to add inorganic compounds such as metal oxides or salts in the compounding device, in order to obtain an agglomerated solid material of loose CNTs comprising mineral compounds that are beneficial for the intended application. We may mention for example soda, zinc oxide or titanium oxide, a carbonate, a hydroxide, a metal oxide or sulphide for example of lithium, manganese, nickel, or cobalt.

It is also possible to add other carbon-containing nanofillers such as graphene, graphite, or carbon black at a content suitable for the intended application.

The invention will now be illustrated by the following examples, which do not aim to limit the scope of the invention, which is defined by the accompanying claims.

### EXAMPLES

### Example 1: Preparation of an Agglomerated Solid Material of Loose CNTs With a Polypropylene (PP) as the Sacrificial Substance

A PP homopolymer, grade PPH 155 (produced by BRASKEM) was used as the sacrificial substance. The carbon nanotubes (Graphistrength® C100 from ARKEMA) and the PPH 155 were introduced in a weight ratio of 25/75 by means of two gravimetric feeders into the hopper of a BUSS° MDK 45 co-kneader equipped with a recovery extrusion screw and a granulator.

The temperature of the two heating zones of the co-kneader is 290° C. and 240° C. The profile of each kneader zone includes the restriction ring ensuring compression of the material undergoing mechanical shearing applied by the screw of the co-kneader. The recovery extruder was set at 250° C. The final composition was then formed into granules of cylindrical shape with a diameter of 3.5 mm and a length of 3-4 mm.

500 g of granules were fed into a 3-litre vertical cylindrical kiln, heated gradually at 10° C./min to 400° C. under a nitrogen stream, held at 400° C. for 1 hour, and then cooled to room temperature. Granules of the same size as the starting formulation were discharged.

TGA measurement performed on this agglomerated solid material of loose CNTs demonstrates absence of weight loss between 150 and 250° C., indicating absence of organic substance that could be present after thermal decomposition.

The density of the agglomerated solid material obtained is found to be 0.24 g/cm³.

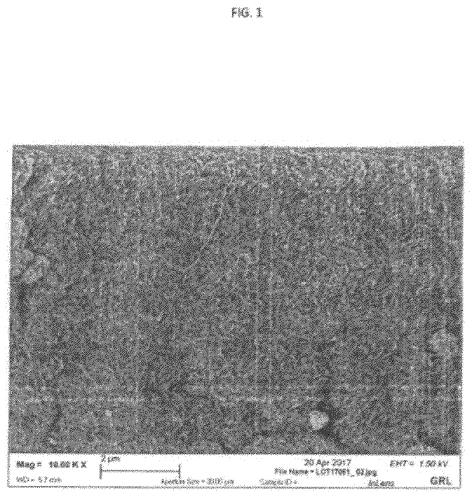

FIG. 1, based on electron microscopy (SEM), shows the morphology of this agglomerated solid material. According to this image, the proportion of CNT aggregates with an average size d50 under 5 μm represents 3% by area.

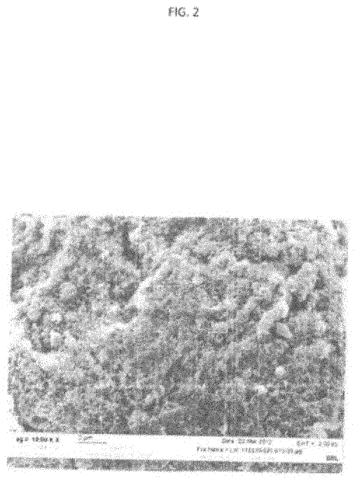

For comparison, FIG. 2 illustrates the morphology of a crude CNT powder, characterized by the presence of more than 90% by area of CNT aggregates with an average size d50 under 5 μm.

### Example 2: Preparation of an Agglomerated Solid Material of Loose CNTs With Water

In this example, the sacrificial matrix used is demineralized water.

The equipment used is identical to that in example 1.

The CNTs (Graphistrengthx C100 from ARKEMA) were introduced into the hopper of the co-kneader by the gravimetric feeder, and water, preheated to 60° C., was injected by the piston pump into the 1st zone of the co-kneader. The proportion of CNTs was set at 25 wt % relative to the water. The temperature of the mixture was kept below 100° C.

The mixture was formed into granules with a diameter of 4 mm and a length of 4-5 mm. Then the granules were fed into a ventilated stove heated to 130° C. After drying for 3 h, the agglomerated solid material of CNTs in the form of granules has the same appearance as the material obtained in example 1.

The density is found to be 0.22 g/cm³.

### Example 3: Production of Polymer-Based Formulations With an Agglomerated Solid Material of Loose CNTs According to the Invention

EPDM rubber, grade VISTALON 2504N, was used as the polymer base.

The reference formulation without carbon-containing additives is as follows:

| | | |
|---|---|---|
| Stearic acid | 2 | phr |
| ZnO | 5 | phr |
| ZDTP (Mixland + 50GA F500) | 3.1 | phr |
| TBBS (Mixland + 75GA F500) | 2.67 | phr |
| S80 (Mixland S80 GAF500) | 1.5 | phr |

CNTs were added at 3 phr and at 7 phr in 4 different forms:
Formulation 1: agglomerated solid material according to the invention from example 1
Formulation 2: agglomerated solid material according to the invention from example 2
Formulation 3: CNTs in the form of powder, commercial grade from ARKEMA Graphistrength ° C.100
Formulation 4: Commercial masterbatch from ARKEMA: Graphistrength C EPDM 20, containing 20 phr of CNT Graphistrength C100

Preparation of the Formulations

1st Mixing Step

The mixer used has a mixing capacity of about 260 cm3 (FIG. 1). The chamber of the kneader has two rotors of the Banbury tangential type. The rotors are controlled by a motor equipped with a speed variator.

Mixing Protocol:

T tank=90° C.

TABLE 1

| Time (min) | n (rpm) | Action |
|---|---|---|
| 0 | 90 | Introduction of the rubber |
| 1 | 50 | Introduction of the various |
| | | forms of CNTs |
| 2 min30 | 70 | Introduction of stearic acid |
| | | and ZnO |
| 5 min30 | 90 | Discharge |

2nd Step: Formulation With the Vulcanization Additives in the External Mixer

The open mill consists of two cylinders rotating in opposite senses of rotation at identical or different speeds. The ratio of the 2 speeds is called the coefficient of friction.

The external mixer is used here to achieve a dispersive state in the mixture and introduce the vulcanization system (sulphur and accelerators).

TABLE 2

| T cylinders = 50° C. | Gap (mm) | ω AV (rpm) | ω AR (rpm) |
|---|---|---|---|
| Recovery | 1.2 | 20 | 22.4 |
| Introduction | | | |
| Extrusion 18 | | 0.9 | |
| offcuts | | | |
| Outlet | | 1.9-2 | |

The densities were measured on the crude materials after introduction of the vulcanization system, on a helium pycnometer. The mixtures with more CNT filler are logically denser than the mixtures with a lower level of filler.

TABLE 3

| | Formulation 1 | | Formulation 2 | | Formulation 3 | | Formulation 4 | |
|---|---|---|---|---|---|---|---|---|
| CNTs, phr | 3 | 7 | 3 | 7 | 3 | 7 | 3 | 7 |
| Density, g/cm³ | 0.91 | 0.92 | 0.88 | 0.91 | 0.86 | 0.89 | 0.89 | 0.91 |
| at 20° C. | | | | | | | | |

Formulations 1 and 2 prepared with the agglomerated solid material comprising loose CNTs have comparable density values.

Formulation 3 prepared with CNTs in the form of primary aggregates (Graphistrength C100) is characterized by a lower density due to the defects of the possible dispersion.

A Mooney MV One instrument (TA instruments) is then used for characterizing the viscosity. This test consists of measuring the torque required to turn a flat rotor at constant speed (2 rev·min⁻¹) in a hermetic cylindrical chamber filled with rubber, with a volume equal to 25 cm³, and heated at constant temperature.

The resistance exerted by the rubber to this rotation corresponds to the Mooney consistency of the elastomer. It is expressed as an arbitrary unit proportional to the measured torque, called Mooney unit (MU).

It is established that 1 Mooney unit is equal to 0.083 N.m.

The introduction of a higher level of CNTs leads to an increase in the Mooney ML(1+4) 100° C. for each formulation. The more the viscosity increases, the better is the distribution of the CNTs in the volume.

TABLE 4

| | Formulation 1 | | Formulation 2 | | Formulation 3 | | Formulation 4 | |
|---|---|---|---|---|---|---|---|---|
| CNTs, phr | 3 | 7 | 3 | 7 | 3 | 7 | 3 | 7 |
| ML(1 + 4) | 37.3 | 45.3 | 36.5 | 42.4 | 29.8 | 33.4 | 35.6 | 38.7 |
| 100° C. | | | | | | | | |

Formulations 1 and 2 are superior to formulation 3 comprising crude CNTs introduced in the form of powder.

Formulations 1 and 2 are superior to formulation 4, which comprises CNTs already pre-dispersed in a masterbatch.

These results confirm that the loose CNTs present in the agglomerated solid material according to the invention display superior dispersibility relative to crude CNT powder, and also superior relative to crude CNTs already pre-dispersed in the same polymer matrix.

### Example 4: Vulcanized Materials Containing the Agglomerated Solid Material According to the Invention

Forming of the elastomer-based formulations obtained in example 3 was done by thermocompression on a 30T platen press. The crude mixture is positioned in a frame with a thickness of 2 mm between two Teflon papers, in their turn sandwiched between two steel plates. The forming temperature is fixed at 165° C., and the vulcanizing time is determined by measurement of kinetics performed on the RPA measuring instrument.

Kinetic monitoring of the vulcanization of the mixtures was performed within a moving-chamber rheometer. An RPA Elite rheometer made by TA Instruments was used.

The sample, with a volume equal to 4 cm³, is placed in a thermally regulated chamber. The variation of the resisting torque opposed by the rubber at low-amplitude oscillation (0.2; 0.5; 1; 3° of arc) of a twin-cone rotor is measured. The frequency of oscillation is fixed at 1.67 Hz.

The measurements were performed at a temperature of 180° C. for 20 minutes with an angle of 0.5° of arc.

The values of t95 measured by the RPA are given in the following Table 5:

TABLE 5

| | Formulation 1 | | Formulation 2 | | Formulation 3 | | Formulation 4 | |
|---|---|---|---|---|---|---|---|---|
| CNTs, phr | 3 | 7 | 3 | 7 | 3 | 7 | 3 | 7 |
| t95 | 9 min 34 s | 8 min 16 s | 10 min 20 s | 9 min 17 s | 8 min 30 s | 8 min 7 s | 8 min 52 s | 7 min 46 s |

Plates were moulded at 180° C. at t95 on the 30T platen press. Mechanical testing was carried out according to standard ISO37 on the INSTRON Universal Tensile tester at room temperature. The standardized test specimens were cut out beforehand:

As shown by the results in Table 6, formulations 1, 2 and 4 are all superior in tensile properties relative to formulation 3 made with CNT powder.

The loose CNTs present in the agglomerated solid material prepared in example 2 in the hydrophilic medium have slightly lower performance than those obtained with the loose CNTs present in the agglomerated solid material prepared in example 1 in the hydrophobic medium.

TABLE 6

| | Formulation 1 | | Formulation 2 | | Formulation 3 | | Formulation 4 | |
|---|---|---|---|---|---|---|---|---|
| CNTs, phr | 3 | 7 | 3 | 7 | 3 | 7 | 3 | 7 |
| M10% (MPa) | 0.32 | 0.44 | 0.30 | 0.40 | 0.26 | 0.32 | 0.34 | 0.42 |
| M50% (MPa) | 0.97 | 1.24 | 0.90 | 1.17 | 0.74 | 0.86 | 1.00 | 1.26 |
| M100% (MPa) | 1.38 | 1.80 | 1.26 | 1.67 | 1.01 | 1.20 | 1.43 | 1.89 |
| M200% (MPa) | 2.01 | 2.71 | 1.77 | 2.38 | 1.42 | 1.97 | 2.09 | 2.88 |
| M300% (MPa) | 2.90 | 3.88 | 2.41 | 3.23 | 2.11 | 2.75 | 2.89 | 4.06 |
| R rupture | 2.85 | 3.47 | 2.68 | 2.94 | 1.64 | 2.07 | 2.72 | 4.57 |
| (MPa) | | | | | | | | |
| Elongation | 292 | 320 | 326 | 331 | 344 | 321 | 333 | 333 |
| at rupture, % | | | | | | | | |

The mechanical behaviour at 60° C. was evaluated for the 4 formulations.

The scanning tests in deformation (Table 7) were carried out at 10 Hz and 60° C. on samples crosslinked for 10 minutes at 180° C., vulcanization carried out in the RPA.

TABLE 7

| | Formulation 1 | | Formulation 2 | | Formulation 3 | | Formulation 4 | |
|---|---|---|---|---|---|---|---|---|
| CNTs, phr | 3 | 7 | 3 | 7 | 3 | 7 | 3 | 7 |
| G*max(MPa) | 0.91 | 1.20 | 0.86 | 1.09 | 0.74 | 0.93 | 0.93 | 1.01 |
| G*min(MPa) | 0.65 | 0.78 | 0.56 | 0.65 | 0.51 | 0.66 | 0.63 | 0.67 |
| ΛG*(MPa) | 026 | 0.42 | 0.30 | 0.44 | 0.23 | 0.27 | 0.29 | 0.34 |
| Tan δ max | 0.13 | 0.17 | 0.13 | 0.17 | 1.42 | 1.97 | 0.12 | 0.15 |

As expected, the PAYNE effect or non-linearity, represented by delta G*, is greater for the filled mixtures. This parameter is connected with the state of dispersion. According to this criterion, the loose CNTs according to example 2 give a very good result for dispersibility, better than the masterbatch of the prior art (formulation 4). The tensile test results for formulation 2, which are lower, can be explained more by the more favourable CNT/EPDM interfaces in the hydrophobic systems.

### Example 5: Electrical Performance of the Formulations

Measurements of electrical resistance R are carried out on plates with a thickness of 2 mm, with a size of 100×100 mm. In this case either surface conductivity or volume conductivity may be measured. The resistivity ρ (Ω·Cm) or the electrical conductivity σ=1/ρ (S·cm⁻¹) is calculated from the measurement of the resistance and according to the geometry of the test specimen and of the probe. Or a volume measurement is obtained using strips of crosslinked mixtures on which an electrode is painted with silver paint.

The results obtained for the 4 formulations are presented in Table 8 below.

TABLE 8

| | Formulation 1 | | Formulation 2 | | Formulation 3 | | Formulation 4 | |
|---|---|---|---|---|---|---|---|---|
| CNTs, phr | 3 | 7 | 3 | 7 | 3 | 7 | 3 | 7 |
| Volume conductivity, | 5.5E−12 | 1.1E−4 | 3.5E−12 | 2.1E−3 | 8E−13 | 4E−7 | 2E−13 | 3.1E−3 |
| S · cm⁻¹ | | | | | | | | |

The agglomerated solid material of the invention makes it possible to approach the antistatic domain, even at the low level of 3 phr, by marking the start of percolation.
At 7 phr, it is formulation 2 that displays performance at the same level as formulation 4 of the prior art, prepared from a masterbatch comprising a pre-dispersion of the crude CNTs, which is to date the best technological approach, transferable to the industrial scale.

The agglomerated solid material of the invention makes it possible to obtain similar or superior results relative to this reference from the prior art, in terms of mechanical or electrical properties.

The agglomerated solid material of the invention is usable for a large choice of polymer matrices, and thus becomes a universal solution for efficiently introducing CNTs, in contrast to the “masterbatch” approach, which requires a similar nature of the matrix of the CNT concentrate and of the polymer matrix of the application.

1. Agglomerated solid material in any rough shape whose smallest dimension is greater than 1 millimetre, comprising loose carbon nanotubes (CNTs) that are free from organic compounds, consisting of a continuous network of carbon nanotubes comprising aggregates of carbon nanotubes with an average size d50 under 5 μm, in a proportion below 60% by area, determined by image analysis by electron microscopy characterized in that it has an apparent density of between 0.01 g/cm³ and 2 g/cm³.

2. Material according to claim 1, characterized in that it comprises at least one chemical compound of an inorganic nature intimately incorporated in the continuous network of carbon nanotubes.

3. Material according to claim 1, characterized in that it has an apparent density between 0.1 and 1.0 g/cm³.

4. Method for preparing an agglomerated solid material as defined according to claim 1, characterized in that it comprises at least one step of compression of a carbon nanotube powder in the presence of at least one sacrificial substance, and optionally of at least one inorganic compound, followed by high-shear mixing of the powder in the compressed state, then forming to obtain an agglomerated solid material and final removal of the sacrificial substance.

5. Method according to claim 4, characterized in that it comprises at least the following steps:
a) charging a compounding device with carbon nanotubes in the powdered state and at least one sacrificial substance in a weight ratio from 10/90 to 40/60, and optionally at least one inorganic compound;
b) mixing the carbon nanotubes and the sacrificial substance in said device to form a mixture in an agglomerated physical form;
c) recovering the mixture in the form of agglomerated solid material;
d) removing the sacrificial matrix.

6. Method according to claim 4, characterized in that the sacrificial substance is a solvent that does not leave any residue after it is removed by drying the agglomerated solid material, an organic substance that does not leave any residues after pyrolysis of the agglomerated solid material, or a substance in the supercritical state.

7. Method according to claim 4, characterized in that the carbon nanotubes in the powdered state are crude, purified and/or oxidized.

8. Method according to claim 4, characterized in that the inorganic compound comprises entities of a metallic nature, carbon, silicon, sulphur, phosphorus, boron, and other solid elements; metal oxides, sulphides, or nitrides; hydroxides and salts; ceramics of complex structure or mixtures of all these inorganic materials.

9. Agglomerated solid material obtainable by the method as defined according to claim 4, characterized in that its percentage porosity corresponds to the volume fraction of the sacrificial substance implemented in the method.

10. Use of the agglomerated solid material according to claim 1 for incorporating carbon nanotubes in water-based or organic liquid formulations.

11. Use of the agglomerated solid material according to claim 1 for manufacturing composite materials, of the thermoplastic or thermosetting type.

12. Use of the agglomerated solid material according to claim 1 for preparing elastomer compositions.

13. Use of the agglomerated solid material according to claim 1 for making components of batteries and supercapacitors.

14. Use of the agglomerated solid material according to claim 1 for preparing electrode formulations for lithium-ion batteries, lithium-sulphur batteries, sodium-sulphur batteries, or lead-acid batteries or other types of energy storage systems.

15. Use of the agglomerated solid material according to claim 1 for preparing catalyst supports making up electrodes.
